(19) United States
(12) Patent Application Publication
(10) Pub. No.: US 2016/0167319 A1
(43) Pub. Date: Jun. 16, 2016

(54) Thread Manufacture for Filament Wound Mandrel

(71) Applicant: Weatherford Technology Holdings, LLC, Houston, TX (US)

(72) Inventors: Stosch S. Sabo, Mason City, IA (US); Matthew R. Stage, Dayton, MN (US)

(21) Appl. No.: 14/970,829

(22) Filed: Dec. 16, 2015

Related U.S. Application Data
(60) Provisional application No. 62/092,600, filed on Dec. 16, 2014.

(51) Int. Cl. B29C 70/86; B29C 70/84; E21B 17/042; B29C 70/06

(52) U.S. Cl. CPC B29C 70/865; B29C 70/06; B29C 70/84; E21B 17/042; B29L 2001/00

(57) ABSTRACT

A continuously reinforced composite mandrel is molded by creating an excess of material through a tapered cone and pressing a male thread profile on the exterior of the mandrel at the excess. To form the female thread, an integral component can be used as a separate component in the mandrel to mold the shape of the threads. The integral component is a sufficiently thin shell to transfer mechanical loads to the composite mandrel (i.e. the integral component does not carry significant mechanical loads). Alternatively, to form female threads, a coil is wrapped with the composite material when the mandrel is formed, and the coil is compressed or twisted to an expanded width to form the female threads inside the mandrel. When the coil is relieved, it can be removed from the formed threads.

### CROSS-REFERENCE TO RELATED APPLICATIONS

This application claims the benefit of U.S. Provisional Appl. 62/092,600, filed 16 Dec. 2014, which is incorporated herein by reference.

### BACKGROUND OF THE DISCLOSURE

Composite mandrels are used in downhole applications for their drillability, strength, and temperature resistance. The most economical method for manufacturing a composite mandrel is by filament winding. When used downhole, the composite mandrel is typically fastened to other components by shear screws, adhesive bonding, or threading.

As an example, FIG. 1 shows a conventional downhole plug P in partial cross-section. The plug P generally includes a mandrel 10, slips 12a-b, expansion cones 14, backup rings 16, and a synthetic sealing member 18. When the plug P is actuated, the sealing member 18 is used to seal an annular area between the plug P and an inner wall of casing within a wellbore. The above elements are similar to the components disclosed in U.S. Pat. No. 6,712,153, which is incorporated herein by reference in its entirety. The mandrel 10 (as well as most other components) are composed of a composite material.

Various forms of shear pins, adhesive bonding, and the like are used to couple together components on downhole mandrels, such as the plug's mandrel 10. In some circumstances, threading may be used to connect some components. For example, the mule shoe 11 may connect onto the end of the mandrel 10 with threads 13. Also, a portion of the internal bore of the mandrel 10 may have threads 17 to connect to some form of plug, launching tool, or the like.

Currently, any form of threads for use on a composite mandrel need to be machined after curing the filament wound composite. Filament wound mandrels are too consolidated to allow for reliable molding of the threads post-wrapping. The consolidated material does not move when the overmold is applied, and fiber breakage can occur in the material. Consequently, threads are machined onto the finished composite mandrel.

As shown in FIG. 2A, for example, a machining tool 26 can cut thread 24 into the surface of a mandrel component 20 after the composite material has been formed. However, such post-cure machining breaks the continuous fiber reinforcement 22 of the filament winding. In the end, this reduces the mechanical properties of the thread 24—particularly limiting the mechanical properties at elevated temperatures.

For example, U.S. Pat. No. 5,398,975 discloses how to form a machined pin connection and a tool-molded box connection on a composite mandrel. Different materials are used to optimize wear/galling. Unfortunately, as already noted, machining breaks the reinforcement and thereby reduces the mechanical advantage of continuous reinforcement.

Rather than machining, some female threads are molded on a composite mandrel by a contour on a tooling core. However, this procedure requires the manufactured part to have a significant draft angle with the mold so the part can be removed from the mold. For example, U.S. Pat. No. 5,233,737 discloses a technique for overwrapping a threaded profile on a tool and then removing the threaded profile. The disclosed technique requires a substantial draft angle in the thread profile to enable post-cure release of the tool.

Additionally, there is potential damage during de-molding in such a molded arrangement since large torque forces may be applied to separate the composite mandrel from the tool containing the thread. Rather than requiring draft angle to remove the components from the mold, some molding techniques for female threads use a multi-piece expandable tool with the desired thread profile. This technique tends to leave flash on the molded thread that reduces the thread's quality.

Rather than machining and molding, some thread profiles are bonded to or embedded in the composite mandrel. As shown in FIG. 2B, for example, a metal component 30 can have thread 34 on its inside bore 32, and the composite material 22 of the mandrel 20 is formed around the component 30. For instance, U.S. Pat. No. 5,350,202 discloses using an integral, overwrapped metal component to provide thread on a composite component. The integral component is used for its material strength. However, this technique of over-wrapping an integral threaded component reduces the overall strength and mechanical properties of the mandrel as a whole by embedding a discontinuity (relative to the mandrel wall thickness) in the mandrel.

Due to the limitations noted above, composite mandrels, components, and the like are usually not threaded for making connections. Instead, metal threaded components are wrapped with the composite materials, or connections between composite components are simply glued or pinned together.

The subject matter of the present disclosure is directed to overcoming, or at least reducing the effects of, one or more of the problems set forth above.

### SUMMARY OF THE DISCLOSURE

One method of fabricating a mandrel of composite material produces integral external thread on the outside of the mandrel. An expanded component is disposed on a core, and the mandrel is formed on the core and the expanded component by winding the composite material thereon. A flare of the wound composite material is produced on the formed mandrel at the expanded component. A first thread is formed externally on an outside surface of the mandrel by pressing the produced flare with a mold having a relief of the first thread.

In forming the first thread externally on the outside surface of the mandrel, the expanded component is removed from the core. To press the produced flare with the mold having the relief of the first thread, at least two mold components can press together about the produced flare of the mandrel (after or while the expanded component is removed).

Other threads can be formed on the same mandrel. Additionally, a number of finishing steps can be performed to the mandrel. For example, the formed mandrel can be cured and the like, and at least a portion of the core can be removed from the formed mandrel to produce an internal passage or bore. Alternatively, all or part of the core may remain as an integral part of the mandrel.

An apparatus for fabricating the mandrel of composite material with the integral external thread on the outside of the mandrel can include a core, an expanded component, and a mold. The core has the composite material wound thereabout for the mandrel. The expanded component positions on the core and has the composite material wound thereabout as the produced flare on the mandrel. Finally, the mold has a relief of a first thread defined therein and is pressable externally on an outside surface of the mandrel at the flare to create the integral external thread.

One method of fabricating a mandrel of composite material produces integral internal thread on an inside surface of the mandrel. A shell is formed having a first thread formed about an internal bore, and the shell is disposed on a core. The mandrel is formed on the core and the shell by winding the composite material thereon, and at least a portion of the core is removed from the shell, which leaves the first thread at the integral internal thread of the mandrel.

The shell is preferably produced with fixture elements on an external surface of the shell. In this way, when forming the mandrel on the core and the shell, the composite material can be wound on the fixture elements of the shell. In general, the shell can be a sleeve of composite or other material having a thin sidewall thickness.

An apparatus for fabricating the mandrel of composite material with the integral internal thread on the inside of the mandrel can include a core and a shell. The core has the composite material wound thereabout for the mandrel. The shell positions on the core and also has the composite material wound thereabout. The shell having the thread formed about an internal bore.

In another method of fabricating a mandrel of composite material to produce integral internal thread on an inside surface of the mandrel involves disposing an expandable component on a core. The mandrel is formed on the core and the expandable component by winding the composite material thereon. A first thread is formed internally on an inside surface of the mandrel by expanding the expandable component, unexpanding the expandable component, and removing at least the expandable component from the formed mandrel. For example, expanding the expandable component can involve compressing a coil and/or twisting a coil.

Other threads can be formed on the same mandrel. Additionally, a number of finishing steps can be performed to the mandrel. For example, the formed mandrel can be cured and the like, and at least a portion of the core can be removed from the formed mandrel to produce an internal passage or bore. Alternatively, all or part of the core may remain as an integral part of the mandrel.

An apparatus for fabricating the mandrel of composite material with the integral internal thread on the inside of the mandrel can include a core and an expandable component. The core has the composite material wound thereabout for the mandrel. The expandable component, which can be a coil, is positioned on the core and has the composite material wound thereabout. The expandable component is expandable to an expanded condition with a first thread profile engageable internally on an inside surface of the mandrel to produce the mandrel's integral internal thread.

As noted above, the expandable component can be a coil disposed on the core. The coil can be compressible on the core to expand outward to the expanded condition. For example, an end piece disposed on a portion of the core can be moved against the coil to compress the coil thereon to the expanded condition and/or can be rotated thereon to twist the coil to the expanded condition.

According to the present disclosure, a continuously reinforced composite mandrel is molded by creating an excess of material through a tapered cone and pressing a male thread profile on the exterior of the mandrel at the excess. To form the female thread, an integral component can be used as a separate component in the mandrel to mold the shape of the threads. The integral component is a sufficiently thin shell to transfer mechanical loads to the composite mandrel (i.e. the integral component does not carry significant mechanical loads). Alternatively, to form female threads, a coil is wrapped with the composite material when the mandrel is formed, and the coil is compressed or twisted to an expanded width to form the female threads inside the mandrel. When the coil is relieved, it can be removed from the formed threads.

For each of the disclosed techniques, the thread is molded and not machined (except in finishing steps). These molding techniques reduce or eliminate the typical machining time required and increase the thread's strength (especially at elevated temperatures).

The foregoing summary is not intended to summarize each potential embodiment or every aspect of the present disclosure.

### BRIEF DESCRIPTION OF THE DRAWINGS

FIG. 1 illustrates a downhole tool having a composite mandrel of the prior art.

FIG. 2A illustrates a prior art technique for forming an external, male thread on a composite mandrel.

FIG. 2B illustrates a prior art technique for forming an internal, female thread on a composite mandrel.

FIGS. 3A-3C illustrate views of core components for forming a composite mandrel having internal and external threads according to the present disclosure.

FIG. 4 illustrates an embodiment of a composite mandrel formed according to the present disclosure.

FIG. 5A illustrates a schematic of a winding apparatus for forming a composite mandrel of the present disclosure.

FIG. 5B illustrates a filament winding process for forming a composite mandrel of the present disclosure.

FIG. 6A illustrates one example of core components for forming a composite mandrel of the present disclosure.

FIG. 6B illustrates mold components for forming the disclosed composite mandrel.

FIGS. 7A-7C illustrates stages of forming the disclosed composite mandrel of FIG. 4 using the core and mold components of FIGS. 6A-6B.

FIGS. 8A-8B illustrate details of the threads formed on the disclosed composite mandrel.

FIGS. 9A-9C illustrate views of other core components for forming a composite mandrel having internal and external threads according to the present disclosure.

FIG. 10A-10D illustrates a stage of forming a composite mandrel using the core components of FIGS. 9A-9C.

### DETAILED DESCRIPTION OF THE DISCLOSURE

FIGS. 3A-3C illustrate views of core components 40 for forming a composite mandrel having internal and external threads according to the present disclosure. As an example, FIG. 4 illustrates a mandrel 200 composed of a composite material, such as wound filament and resin matrix, which has been formed using the core components 40 of FIGS. 3A-3C. On the mandrel 200 in FIG. 4, male thread 204 and female thread 206 are integrated into the composite mandrel 200 during fabrication and are not formed by machining.

As shown in FIGS. 3A-3C, the core components 40 include a tooling core or bar 50 about which filament of a composite mandrel is wound to form a cylindrical mandrel. In the present configuration, the tooling core 50 is a tooling piece used to create the inner bore of a composite tube for the cylindrical mandrel or other disclosed component. In this case, the tooling core 50 has an OD generally equal to the desired ID of the formed mandrel. The tooling core 50 is typically composed of metal and is removed from the wound mandrel to leave a central passage or bore therein. Other configurations of tooling core 50 could be used. For example, the core 50 or at least a portion thereof may be designed to remain inside the mandrel 200 as part of the finished product.

One end of the mandrel (200:FIG. 4) may be designed to have an internal female thread (206) so a shell 60 is disposed on one end of the tooling core 50. The other end of the mandrel (200) may be designed to have external male thread (204) so an expansion or flaring component 70 is disposed on the other end of the tooling core 50. As filament winding is performed on the tooling core 50, for example, winding is also performed on the shell 60 and the expansion component 70 so the internal and external threads (204, 206) can be formed on the resulting mandrel (200) without the need to machine the structure of the composite material. In general as discussed below, the male thread (204) is formed via compression molding of a flared, filament-wound taper at the end of the composite mandrel (200) formed by the expansion component 70 during fabrication. The female thread (206) is formed by over-wrapping an integral, non-metallic threaded profile of the shell 60.

In general, the composite mandrel 200 of FIG. 4 can be a component, body, mandrel, etc. of a downhole tool, such as a plug, bridge plug, frac plug, or the like. In fact, any downhole tool, cylinder, tubular, etc. composed of a composite material can benefit from the disclosed techniques. By integrating the male and female threads 204, 206 during fabrication into such a mandrel 200, machine time can be reduced. More importantly, the integral molding of the threads 204, 206 in the composite material of the mandrel 200 can preserve the mechanical advantage of the composite material, such as its continuous fiber reinforcement.

Using these molding techniques to form the male and female threads 204, 206, the composite mandrel 200 does not have to contain a draft with a mold because the threaded profile becomes integral to the mandrel 200. As opposed to using an integral metal member for the female thread 206, the molding technique for the female thread 206 uses a composite or plastic integral member or shell 60. In this way, since the integral shell (60:FIGS. 3A-3C) remains sufficiently thin, the composite mandrel 200 can benefit from the material strength of the filament wound composite.

As a result the disclosed techniques, the entire composite component or mandrel 200 taken as a whole in this disclosure is anticipated to have higher mechanical properties compared to a component manufactured with a prior art technique due to limited lost wall thickness caused by the integral component. In contrast to a machined pin and a molded box, the disclosed techniques instead produces a molded pin 204 and an integrally molded box 206.

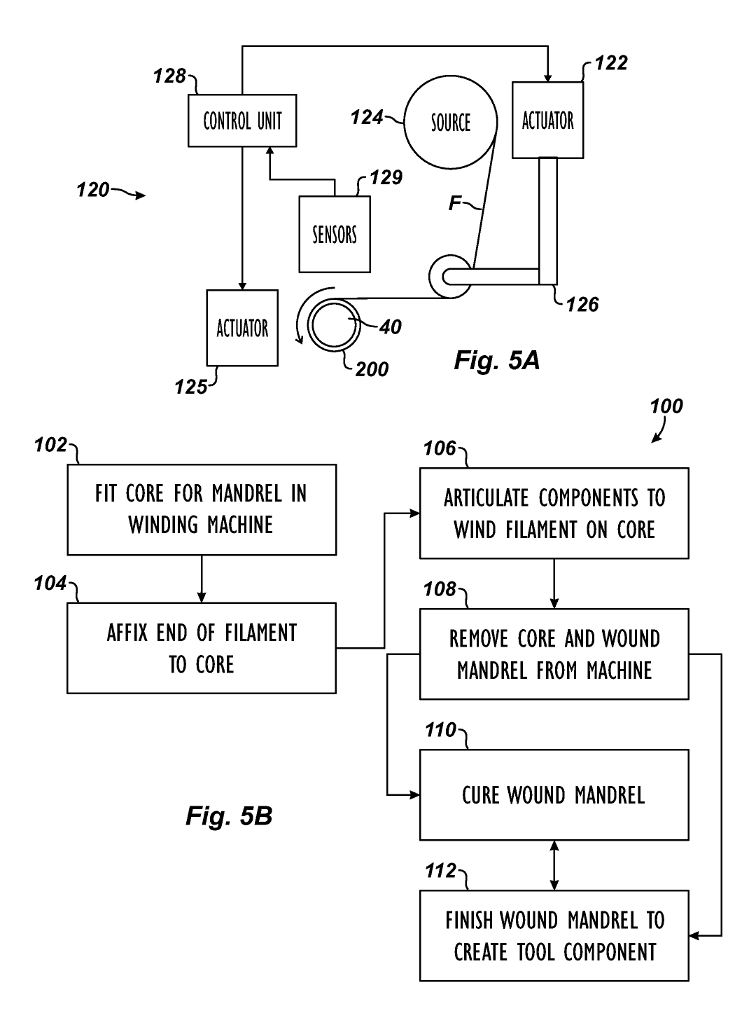

Before discussing most of the particulars of forming the male and female threads 204, 206 on the mandrel 200, FIG. 5A illustrates a schematic of a winding system 120 for forming a mandrel of the present disclosure. The system 120 includes a multi-axis filament winding machine that is capable of articulating (i.e., rotating and translating). Various forms of winding can be used including filament winding, overwrapping, wet wrapping, dry wrapping, infusion, injection, or resin transfer molding processes.

As schematically shown, the system 120 includes a control unit 128 operatively coupled to one or more actuators—only two actuators 122 and 125 are shown for simplicity. The actuators 122 and 125 can be linear and rotational actuators. The control unit 128 controls the actuators 122 and 125 to control the winding of filament F from a source 124 to form the composite mandrel 200 on the core components 40 during a filament winding procedure.

As shown here, a first actuator 125 rotates the core components 40, and a second actuator 122 rotates the source 124. A payout head 126 on the second actuator 122 guides the filament F from the source 124 for forming the composite mandrel 200. The second actuator 122 may be capable of articulating the payout head 126 and control the resulting placement of the filament F in a number of ways to form the composite mandrel 200.

The control unit 128 uses computerized numerical control to operate the various linear and rotational actuators 122 and 125 to wind the filament F. The control unit 128 may further include various types of sensors 129, such as optical sensors, to monitor the winding of the filament F on the core components 40 to form the composite mandrel 200. As will be appreciated, the winding machine of the system 120 has any number of rollers, tensioners, spools, and other components (not shown) that are used for delivering the filament F, controlling its placement, and performing the winding procedures according to the purposes herein. Additionally, the system 120 has various components for handling and applying resin to the filament F, the wound mandrel 200, or both during the winding procedure. These features will be readily appreciated by one skilled in the art having the benefit of the present disclosure.

As can be seen, forming the mandrel 200 on the core components 40 can involve a filament winding process. When the mandrel 200 is to be used for downhole applications, a particularly useful filament winding process disclosed in U.S. Pat. No. 6,712,153 has been used to create composite wound mandrels and other components for downhole use. Such a filament winding process can be used in a similar fashion in winding the composite mandrel 200 of the present disclosure. Accordingly, composition of the mandrel 200 can use a comparable filament F. As such, the composite wound mandrel 200 can be composed of a polymeric composite reinforced by a continuous fiber such as glass, carbon, or aramid; however, the process is not limited to these examples and could be formed using other compositions. In fact, the filament F and resin matrix may comprise any suitable material.

Turning now to FIG. 5B, a process 100 is shown for winding the composite wound mandrel 200 according to the present disclosure. As already noted, various forms of winding can be used including filament winding, overwrapping, wet wrapping, dry wrapping, infusion, injection, or resin transfer molding processes. Filament winding is described here.

Referring concurrently to the system 120 of FIG. 5A, the process 100 in FIG. 5B begins by positioning the core components 40 for forming the mandrel 200 in the winding machine of the system 120 (Block 102). As described in more detail later, the core components 40 can be affixed to a spindle of the winding machine and can be both a permanent and/or temporary structure for the composite wound mandrel 50. To start the winding of the filament F to the core components 40, the end of the filament F is affixed to a portion of the core components 40 so the length of the filament F can be wound about the core components 40 to form the mandrel 200 (Block 104). Initially affixing the filament F to the core can be performed in a number of ways including, mechanically fastening, tying, wrapping, etc. the filament F to the core components 40.

The system 120 then articulates the components of the winding machine to wind the filament F on the core components 40 to create the composite mandrel 200 (Block 106). As will be appreciated, the filament F can be placed in a number of suitable patterns to enhance the strength of the formed mandrel 200. These patterns can be randomized or predetermined depending on the desired results. Overall, the filament F is wound in overlapping layers around the forming mandrel 200, and the overlapping layers are preferably arranged in offset directions or angles so that the windings of the filament F lie in different directions from one layer to the other.

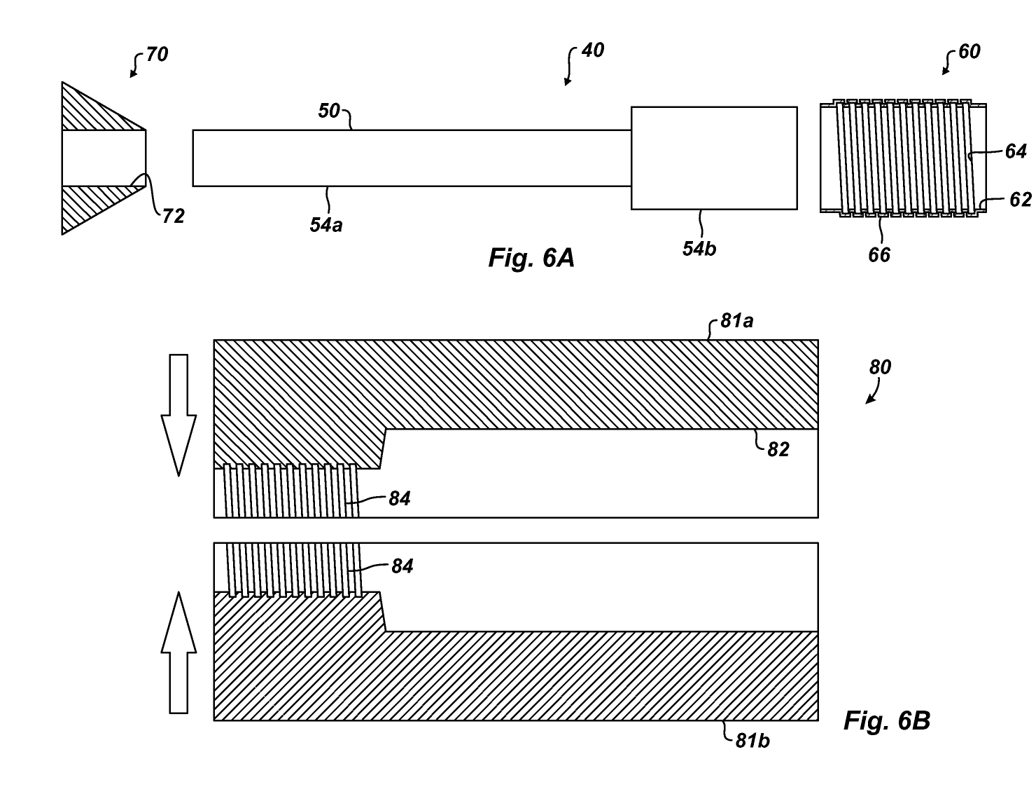

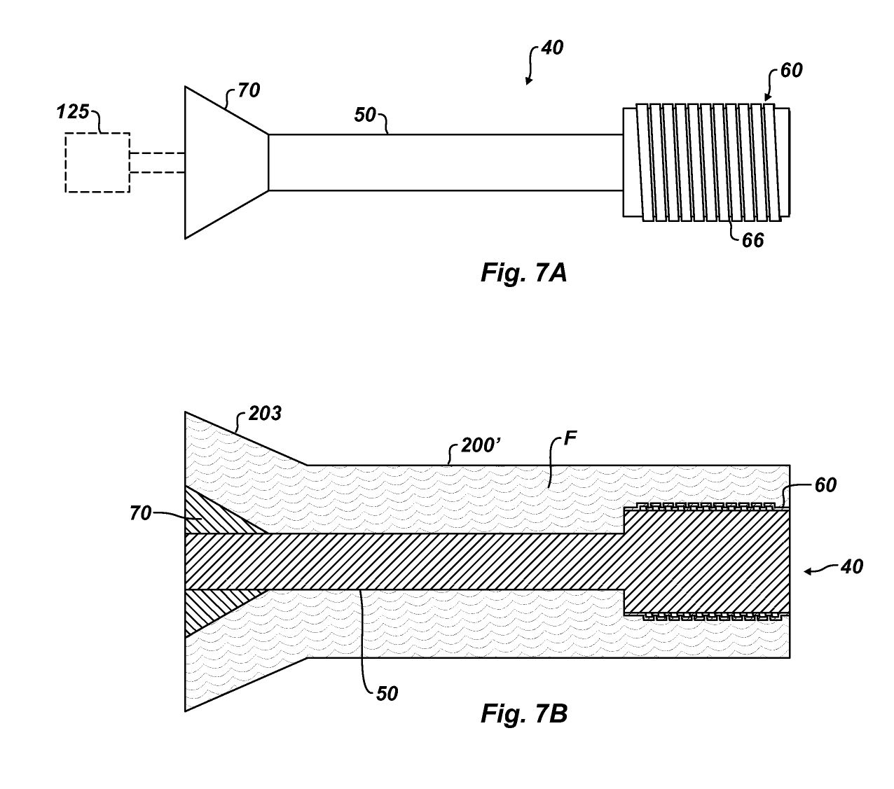

Once the mandrel 200 reaches its suitable size, the formed mandrel 200 and core components 40 can be removed together as a unit from the machine (Block 108). At this point, a number of finishing steps can be performed to prepare the formed mandrel 200 for use. For example, the composite wound mandrel 200 may be molded, cured, and otherwise treated to harden and complete the mandrel 200 (Block 110). Also, the outer dimension and surface of the formed mandrel 200 may be finished by machining, polishing, surfacing, filling, and the like (Block 112) so that the mandrel 200 achieves the desired shape (e.g., cylindrical), uniformity, surface finish, dimensions, etc. As discussed herein, the flaring component 70 is removed after winding and before curing. The mandrel 200 is cured while a mold (e.g., 80:FIG. 6B) is attached to it, and the tooling core 50 is not removed until after curing is complete.

The particular order in which these finishing steps (Blocks 108, 110, & 112) are performed may depend on the winding process. In general, the wound mandrel 200 is cured before the mandrel 200 is machined to a particular shape, dimension, or the like. Additionally, any holes or voids in the wound mandrel 200 may be filled before the mandrel 200 is cured and subsequently machined. These and other considerations will be appreciated with the benefit of the present disclosure.

In the winding steps (Block 106), the filament F of the composite material is wound layer upon interlaced layer around the core components 40. Each individual layer is preferably wound at an angle relative to the previous layer to provide additional strength and stiffness to the composite material in high temperature and pressure downhole conditions. The composite can be polymeric and can use an epoxy blend. However, the polymeric composite may also consist of polyurethanes or phenolics, for example. In one aspect, the polymeric composite uses a blend of two or more epoxy resins. For example, the composite can be a blend of a first epoxy resin of bisphenol A and epichlorohydrin and a second cycoaliphatic epoxy resin.

The filament F is typically wet wound, being impregnated with the matrix material (e.g., resin) before winding. However, dry winding can be used in which a pre-preg roving process forms a matrix. As is known, pre-preg refers to fiber or filament pre-impregnated with a matrix material, such as a bonding agent, resin, epoxy, etc. Although less desirable, the filament F can be wound dry to form the wound mandrel 200 or at least a portion thereof, and the mandrel 200 or portion thereof can be subsequently impregnated with the matrix material (e.g., resin). This can be performed in stages. As will be appreciated, particular handling and curing procedures for the filament F will be required depending on how the filament F is wound (wet, pre-preg, dry, etc.).

In the curing steps (i.e., Block 110), a post-cure process may be used to achieve greater strength of the material. Typically, the post-cure process is a two-stage cure consisting of a gel period and a cross-linking period using an anhydride hardener. Heat is added during the curing process to provide the appropriate reaction energy to drive the cross-linking of the matrix to completion. The composite may also be exposed to ultraviolet light or a high-intensity electron beam to perform the reaction energy to cure the composite material.

With a general understanding of the core components 40 in FIGS. 3A-3C, the winding system 120 in FIG. 5A, and the filament winding techniques as in FIG. 5B, discussion now turns to an example of core components and techniques for forming a composite mandrel having integral male and female threads of the present disclosure. To that end, FIG. 6A illustrates core components 40 for forming a composite mandrel (200: FIG. 4) of the present disclosure, and FIG. 6B illustrates components of a mold 80 for forming the disclosed mandrel 200.

Similar to the previous discussion, the core components 40 include a tooling core or bar 50 in FIG. 6A about which filament is wound to form the composite mandrel (200). The tooling core 50 is typically composed of metal and is removed from the wound mandrel to leave a central passage therein. As shown, the tooling core 50 can have different diameters, such as a thinner diameter 54a at one end opposed to the other end 54b.

One end of the mandrel (200) may be designed to have internal female threads (206) so an inset or shell 60 can be disposed on one end 54b of the tooling core 50. The other end of the mandrel (200) may be designed to have external male threads (204) so a flaring component 70 is disposed on the other end 54a of the tooling core 50. As will be discussed, filament winding is performed on the shell 60 and the flaring component 70 so the internal and external threads (204, 206) can be formed on the resulting mandrel (200) without the need to machine the structure of the composite material.

The shell 60 can be a thin cylinder having female thread 64 formed on an internal bore 62. The shell 60 can be composed of a suitable composite or other material to become part of the finished composite mandrel. For example, the molded shell 60 may be made of a thermoset or thermoplastic resin, an elastomer, or a composite material containing discontinuous reinforcement. The molded shell 60 may be machined, cast, compression molded, transfer molded, or injection molded.

Since the shell 60 is preferably thin, the sidewall of the shell 60 is preferably consistent so that the outside surface of the shell 60 has an inverse thread profile 66. The molded shell 60 is slipped over the tooling core 50 and fastened, locked, secured, etc. in place at the point where the mandrel's female threads (206) will be placed. Because the female thread 64 is intended to receive a male end of another member and thread therewith, the shell 60 may dispose on a wider portion 54b of the tooling core 50. To help with retention, the inverse profile 66 on the shell provides features in which the filament winding can fit. Additionally, the outside area of the molded shell 60 may be prepared by a known surface preparation method to promote bonding. For example, an adhesive may also be applied to the outside area of the molded shell to promote bonding to the matrix resin.

The expansion or flaring component 70 may be made of a metal, elastomer, thermoset, thermoplastic, or composite. As specifically referenced here, the component 70 may be in the shape of a cone used to flare the area in which the mandrel's male thread (204) will be formed. Rather than having the shape of a cone, the flaring component 70 may comprise two or more arms, wedges, inserts, or the like. In either case, the flaring component 70 contains an optimal angle and length to provide a sufficient excess of material at the location of the male (pin) thread (204), as will be discussed below.

The cone 70 has a central bore 72 that fits onto the tooling core 50, and the cone 70 can be fastened in the desired place using a number of techniques, such as pins, fasteners, etc. Because the cone 70 is used in the formation of external male thread (204) on the mandrel (200), the cone 70 can be disposed on the narrower portion 54a of the tooling core 50 to form a male end of the mandrel (200) for mating inside a female end of another component. In other implementations, where internal and external threads are to be formed on a finished mandrel (200) for coupling to larger or smaller components (end rings, subs, etc.), the diameters of the tooling core 50, shell 60, cone 70, etc. can be appropriately modified.

Used with the tooling core 50 and other components, a mold 80 as shown in FIG. 6B can have two or more mold portions 81a-b. The mold 80 can be made of a steel, aluminum, alloy, or composite, and the portions 81a-b of the mold 80 can be fastened together to provide a compressive force by a mechanical means (not shown).

The mold 80 may be used primarily in the formation of the external male thread (204) on the formed mandrel (200), although it could be used to mold other portions of the mandrel (200) as well. In general, to help in the formation of the male thread (204) on the mandrel (200), the mold 80 defines thread relief 84 on the inner surfaces 82 of its mold portions 81a-b. The transferred image of the male thread's profile is contained in this thread relief 84 of the mold 80 so the desired male thread 204 can be formed externally on the mandrel (200).

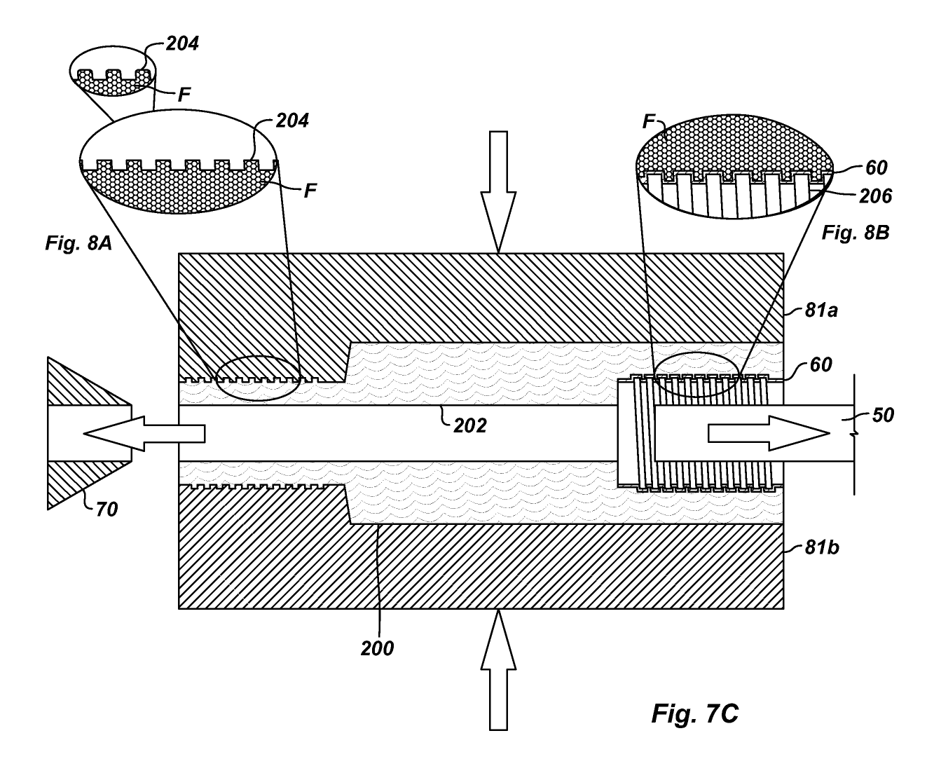

Looking now at FIGS. 7A-7C, stages using the core components 40 and mold 80 are shown to illustrate the process for forming a mandrel 200 with external and internal threads 204, 206.

As shown in FIG. 7A, the core components 40 can be assembled and installed on a rotating actuator 125 of the winding machine, as noted herein. Again, the cone 70 can be placed at one end of the tooling core 50 where male threads are to be formed, and the shell 60 can be placed at the other end of the tooling core 50 where the female threads are to be formed.

Winding procedures can then be performed by winding fed filament (not shown) on the core components 40 as they are rotated. During fabrication, for example, the tooling core 50 and the cone 70 are covered in the filament-wound composite material. In fact, the tooling core 50 can have an OD within 5% of the desired ID of the mandrel 200. As noted previously, the composite material has a continuous reinforcement in the form of a fiber, string, yarn, tow, fabric, or mat material. As also noted previously, the reinforcement may be a ceramic, carbon, aramid, or synthetic reinforcement, and the reinforcement can be immersed, infused, or otherwise covered in a resin which may be a thermoplastic or thermoset.

Ultimately, the composite material takes the form of the tooling core 50 and the flaring cone 70 during the filament winding, overwrapping, wet wrapping, dry wrapping, infusion, injection, or resin transfer molding process. In the end, a cylindrical shaped proto-mandrel 200′ as shown in full cross-section of FIG. 7B can be formed from the wound, impregnated filament F on the core components 40. The filament F has been wound over the tooling core 50, the shell 60, and the cone 70.

Discussion first turns to the details for forming the male thread (204) on the mandrel (200). To mold the male thread (204), the proto-mandrel 200′ as shown in FIG. 7B is first formed with a flare 203 on the end of the proto-mandrel 200′ where the male thread (204) is desired. Again, the cone 70 is used on the end of the tooling core 50 where the flare 203 is produced to form the male thread (204).

This flare 203 having a wider diameter than the proto-mandrel 200′ creates an excess of material relative to the rest of the proto-mandrel 200′ for a desired mandrel ID and wall thickness. As discussed below, this excess material of the flare 203 is sufficient to conform to the mold 80 to create the male thread (204). Additionally, the cone 70 leaves the flare 203 with a volume into which the consolidated material of the proto-mandrel 200′ can move when the mold 80 is applied. In this sense, the flare 203 not only produces an excess of material where the male thread (204) will be, but the flare 203 also makes that excess material movable by increasing both the OD and ID at the flare 203 relative to the rest of the proto-mandrel 200′. Thus, the molding pressures are not expected to break the fibers or winding of the proto-mandrel 200′ because the excess material, even though consolidated, can spread and move into the volume of the OD left by the cone 70 during the molding process.

As shown in FIG. 7C, the male thread 204 is molded on the flared end 203 using the compression mold 80, and the flare 203 provides an excess of material sufficient to fill out the mold 80 and provides a volume into which the material can move during molding. The two or more mold portions 81a-b of the mold 80 can press against the formed mandrel 200. This may be primarily done to complete the formation of the male thread 204 using the relief 84 in the mold 80, but the mold 80 can be used for additional purposes as well, such has forming other reliefs, shoulders, or the like in the mandrel 200.

Again, the cone 70 containing the flared taper and designated length has been placed at the location the male thread 204 is desired, and the filament winding has been built up to thickness on this tapered cone 70 to a determined geometry of the flare (203: FIG. 7B). When the vice-actuated compression mold 80 as shown in FIG. 7C is clamped onto the flared taper (203), the cone 70 is removed or squeezed out to leave a volume into which the material of the flare (203) can move. The effective angle of the cone 70 and the winding thickness of the flare (203) can depend on the particular implementation and are only diagrammatically shown and described herein. In the meantime, the excess, flexible amount of material in the flare (203) remaining then conforms to the mold profile 80 and thread relief 84 when compressed between the original core 50 and the thread mold 80.

As typically used in molding, the thread relief 84 and other portions of the mold 80 may require vents and shut-off surfaces (not shown) at the interface to effectively evacuate excess resin and minimize flash at the parting line of the mold portions 81a-b. Sufficient shut-off surfaces, venting paths, and dump grooves can be contained on the faces of the mold 80 to minimize flash at the parting line. Additionally, sufficient surface finishes, gel-coats, and/or mold release agents can be applied to the molding surface 82 to enhance de-molding. Furthermore, ledges, steps, and or handles can also be added to the mold 80 for ergonomic handling and leverage locations during de-molding.

While in the mold, the formed mandrel 200 can be cured. Then, the mold 80 is removed from the mandrel 200. The mold portions 81a-b are pried apart using ledges and/or steps and known techniques. The molded male thread 204 may then require finishing to remove flash.

Details are now discussed for forming the female thread 206 on the composite mandrel 200. To mold the female thread 206, the thin, non-metallic shell 60 having thread profile 64 is over-wrapped as shown in FIG. 7B in the filament winding process. The thin nature of the shell 60 allows the mechanical loads to be transferred to the composite material of the mandrel 200 while minimizing the impact of the discontinuity in the composite material created by the integral shell 60.

As noted before, the shell 60 is already molded with the non-metallic integral thread profile 64, and the shell 60 can be composed of a thermoset, a thermoplastic, a composite, or an elastomeric material. As shown in FIG. 7A, the shell 60 is placed over the desired portion of the core 50. As then shown in FIG. 7B, the tooling core 50 and the shell 60 are covered in the composite material during fabrication to form the proto-mandrel 200′. As already noted, the composite material can comprise a continuous reinforcement in the form of a fiber, string, yarn, tow, fabric, or mat material, and the reinforcement may be a ceramic, carbon, aramid, or synthetic reinforcement. The reinforcement can be immersed, infused, or otherwise covered in a resin which may be a thermoplastic or thermoset. The composite material takes the form of the core 50 and the molded shell 60 via the filament winding, overwrapping, wet wrapping, dry wrapping, infusion, injection, or the resin transfer molding process used.

Following material placement, compressive pressure will be applied to the OD of the area where the molded shell 60 is located. The compression can be applied using heat-shrink tape, a vice-actuated mold, or an autoclave to ensure sufficient fill of, and bonding to, the shell 60. The compression can be applied for the duration of the cure cycle. As shown in FIG. 7C, a portion of the mold 80 may apply the desired compression. Once molding and curing is done, the composite mandrel 200 is removed from the core 50, and any excess material on the mandrel 200 can be removed by a machining process.

Once complete, the female thread 206 for the mandrel 200 is formed by the shell 60, which acts as an overwrapped shell-profile of the female thread 206. The shell 60 is sufficiently thin to transfer mechanical loads to the composite filament and minimize the amount of wall thickness lost due to the embedding of the shell 60 in the composite material.

As finally completed, the disclosed composite mandrel 200 of FIG. 4 is formed with external, male thread 204 at one end and the internal, female threads 206 at the other. Although it may not have been expressly pointed out previously, it is not necessary that a given mandrel 200 formed according to the present teachings include both male and female threads 204, 206 at each end. Instead, a given mandrel 200 can be formed having one or the other type of male or female thread 204 or 206, or can be formed having both ends with the same type of thread 204 or 206. The dual arrangement of male and female threads 204, 206 is merely provided as an example.

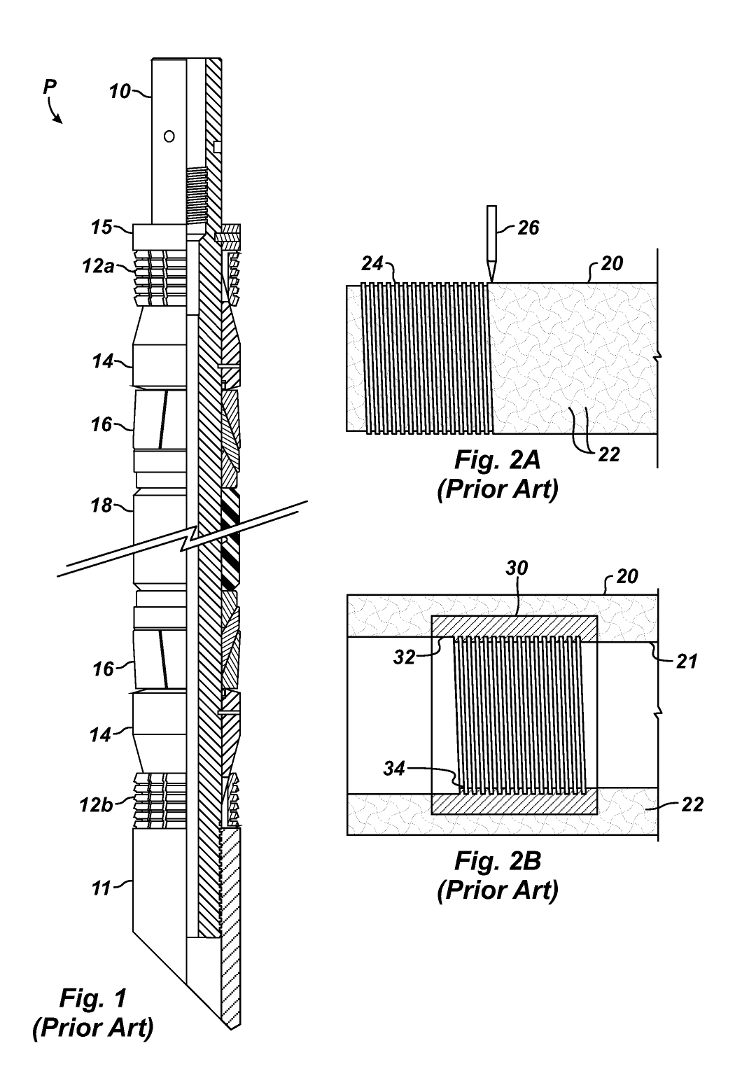

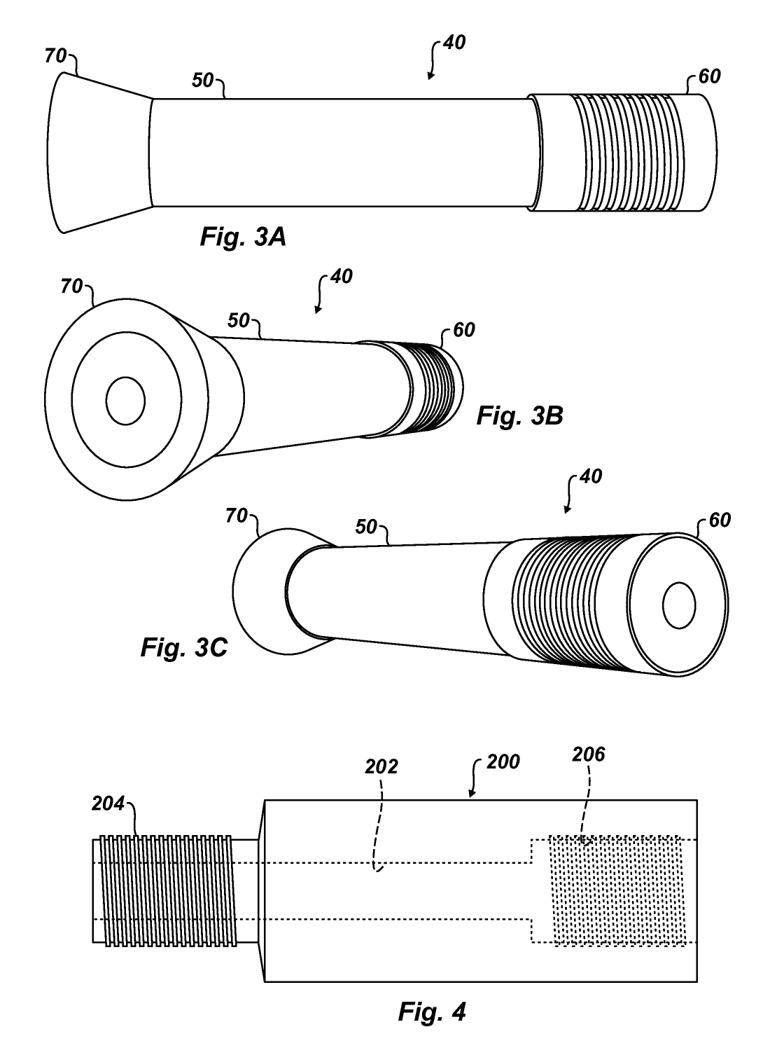

The location of the threads 204 and/or 206 can be different than depicted in the present examples. In particular, locating the thread 204, 206 at ends of the mandrel 200 may be customary for some implementations. For example, the mandrel 200 if used for a composite plug used downhole, such as the plug in FIG. 1, may have thread 204, 206 located near the ends. However, the male and/or female threads 204, 206 of the present disclosure can be formed at other locations of the mandrel 200. For example, the external male thread 204 can be formed at an intermediate location on the mandrel 200. In this instance, the flare 203 can be produced with a properly positioned component 70. Molding the thread 204 with the mold 80 can then involve removing the core 50 so the component 70 can be removed and then reinsertion of the core 50 for the molding.

Advantageously, because machining has not been used to form the threads 204, 206, the filament and matrix structure of the composite mandrel 200 has not been compromised around the area of the threads 204, 206, as this can weaken the strength of the threads 204, 206. In particular, the detail in FIG. 8A shows how the filament winding F of the male thread 204 on the mandrel 200 can remain intact in the teeth of the thread 204. The thread 204 can have sharp edges when molded that may be left in place or may be later rounded. Alternatively, the thread 204 may be directly molded to have rounded edges.

The detail in FIG. 8B shows how the filament winding F of the female thread 206 on the mandrel 200 can remain intact primarily in the teeth of the thread 206 even with the thin shell 60 present. The female thread 206 can have sharp edges or rounded edges as desired.

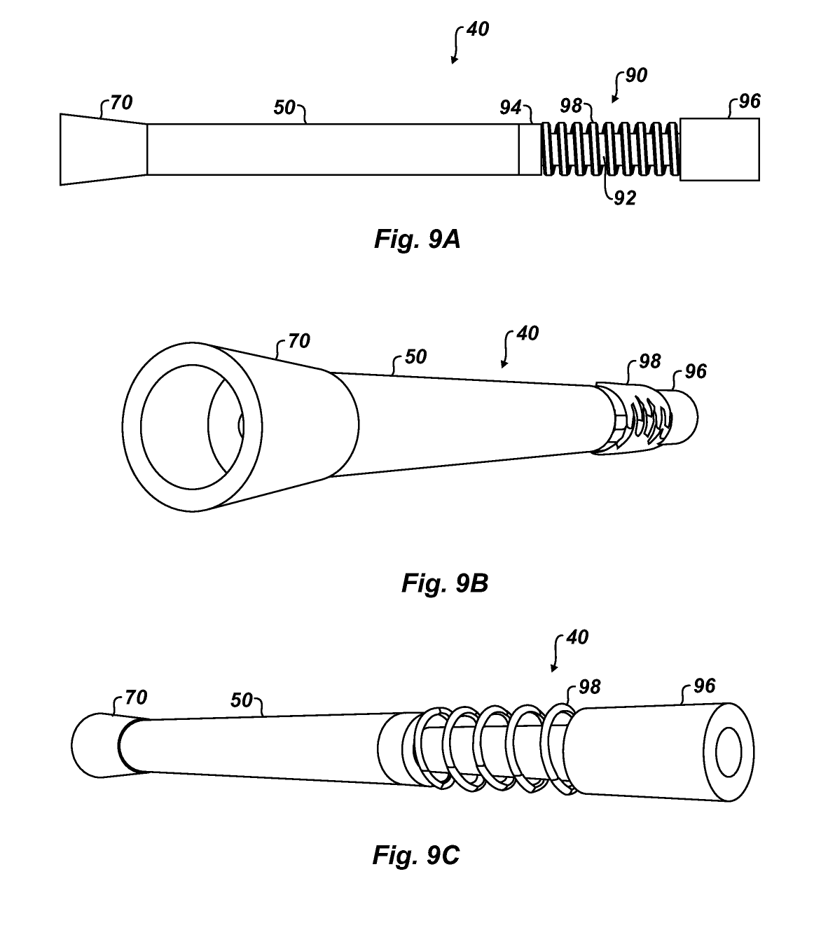

As noted in the previous implementation, the female thread 206 can be formed using the shell 60 in the winding process that becomes an integral component of the wound mandrel 200. An alternative arrangement for forming female threads will now be discussed with reference to FIGS. 9A-9C. Here, core components 40 are shown for forming a composite mandrel (200) having internal and external threads (204, 206) according to the present disclosure.

Formation of the male threads (204) can be similar to the previous implementation and can involve the use of a cone 70, mold relief, etc. To form the female thread (206) on the mandrel (200), however, the core components 40 include an expandable component or coil core 90. A central spindle 92 has an end 94 that can abut, attach to, or be integral with the tooling core 50. A coil or spring 98 is disposed on the central spindle 92, and an end piece 96 fits at the end of the spindle 92 to hold the coil 98 in place.

The first end 94 is tubular and can have a diameter equal to that of the tooling core 50. The spindle 92 extends from the end of 94 and has a second diameter that may be less than the tooling core 50. The coil 98 is slid onto the spindle 92, and the end piece 96 is a tubular component attached onto the spindle 92. The end piece 96 connects to the spindle 92 using thread or the like so the end piece 96 can move on the spindle 92.

The coil 98 is fabricated to produce the inverse profile of the desired female thread (206) when the coil 98 is compressed and/or twisted to an expanded width. The coil 98 is attached between the tubular end 94 and end piece 96. The tubular end piece 96 can be moved to compress the coil 98 to its expanded width. For example, the end piece 96 can be moved closer to the end using thread or the like with the central spindle 92 so the coil 98 is compressed to its expanded width. Alternatively or additionally, the end piece 96 can rotate on the spindle 92, and being affixed to the coil 98, the rotating end piece 96 can expand and contract the coil 98 by twisting the coil 98 depending on which direction the end piece 96 is rotated.

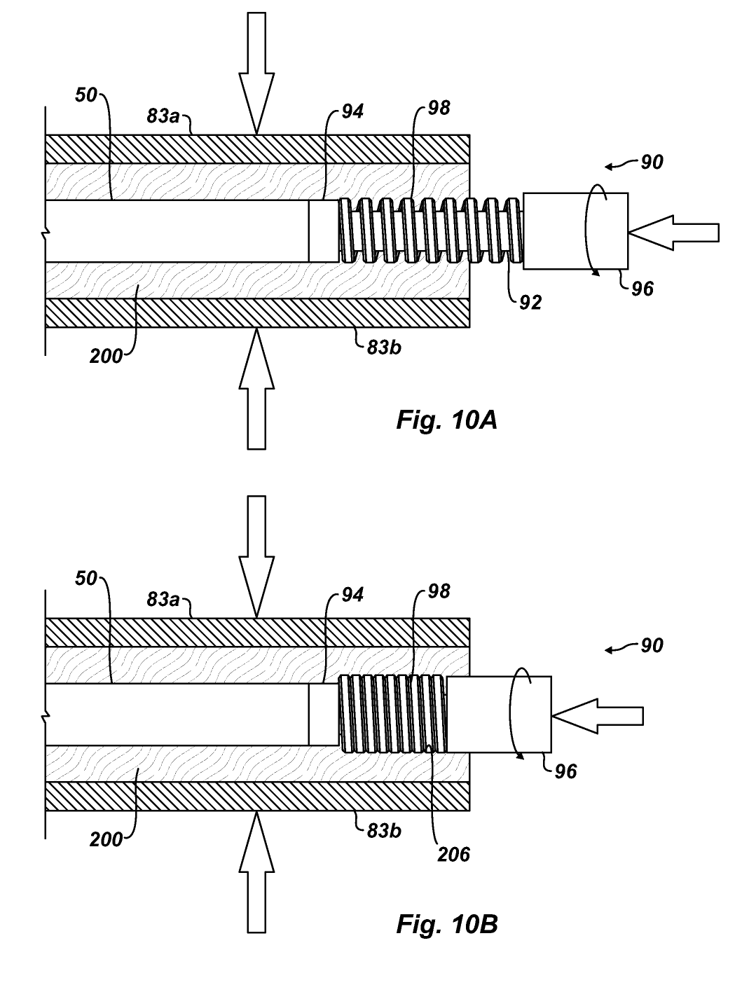

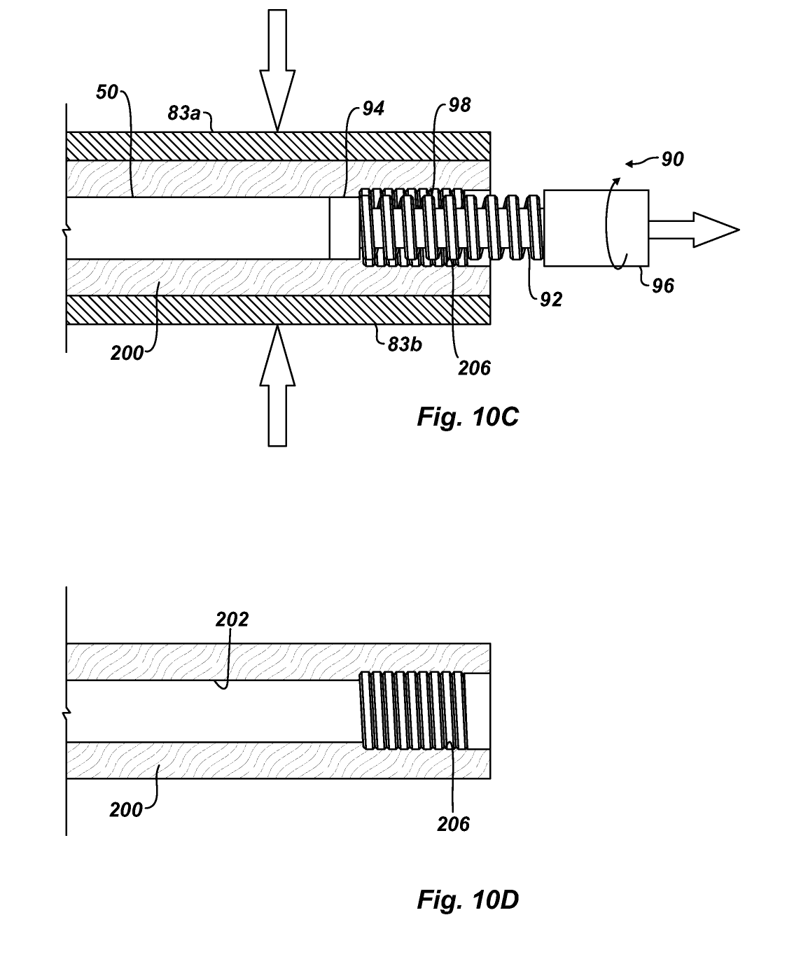

FIGS. 10A-10D illustrate stages of forming a composite mandrel 200 using the core components 40 of FIGS. 9A-9C. Only the end of the mandrel 200 for the female thread 206 is shown. The end 94 of the expandable core 90 is threaded or otherwise situated on the tooling core 50. The expandable core 90 holds the coil 98 at a length greater than its compressed height. In the fabrication process, the winding core 50 and the expandable core 90 are overwrapped by the filament winding in a designated pattern and geometry.

Following the filament winding, the movable end piece 96, as shown in FIG. 10B, is moved inward (e.g. threaded more on the spindle 92) to compress the coil 98. As the coil 98 compresses to its compressed height, it will expand outward, and the inverted thread profile of the coil 98 will mold the female thread 206 onto the interior diameter of the mandrel 200. Mold components 83a-b can be applied to the exterior of the mandrel 200 to provide compressive force so the female thread 206 is molded by using the outward forces created by the coil 98.

The mandrel 200 is then cured. Following cure, the end piece 96, as shown in FIG. 10C, is returned to its original position. This decompresses and shrinks the coil's outer diameter. This allows the tooling core 50 and expandable core 90 to be removed from the composite mandrel 200, leaving a finished piece as shown in FIG. 10D. Additional finishing and preparation steps can then be performed to perfect the female thread 206.

The foregoing description of preferred and other embodiments is not intended to limit or restrict the scope or applicability of the inventive concepts conceived of by the Applicants. It will be appreciated with the benefit of the present disclosure that features described above in accordance with any embodiment or aspect of the disclosed subject matter can be utilized, either alone or in combination, with any other described feature, in any other embodiment or aspect of the disclosed subject matter.

In exchange for disclosing the inventive concepts contained herein, the Applicants desire all patent rights afforded by the appended claims. Therefore, it is intended that the appended claims include all modifications and alterations to the full extent that they come within the scope of the following claims or the equivalents thereof.

What is claimed is:

1. A method of fabricating a mandrel of composite material, the method comprising:
disposing an expanded component on a core;
forming the mandrel on the core and the expanded component by winding the composite material thereon;
producing a flare of the wound composite material on the formed mandrel at the expanded component; and
forming a first thread externally on an outside surface of the mandrel by pressing the produced flare with a mold having a relief of the first thread.

2. The method of claim 1, wherein forming the first thread externally on the outside surface of the mandrel comprises removing the expanded component from the core.

3. The method of claim 1, wherein pressing the produced flare with the mold having the relief of the first thread comprises pressing at least two mold components together about the produced flare of the mandrel.

4. The method of claim 1, further comprising curing the formed mandrel.

5. The method of claim 1, further comprising removing at least a portion of the core from the formed mandrel.

6. The method of claim 1, further comprising forming a second thread on the mandrel.

7. The method of claim 6, wherein forming the second thread on the mandrel comprises:
initially forming a shell having the second thread formed about an internal bore, and disposing the shell on the core; and
wherein forming the mandrel further comprises forming the mandrel on the shell by winding the composite material thereon, and removing at least a portion of the core from the shell.

8. An apparatus for fabricating a mandrel of composite material, the apparatus comprising:
a core about which the composite material is wound for the mandrel;
an expanded component positioning on the core and about which the composite material is wound as a flare on the mandrel; and
a mold having a relief of a first thread defined therein and being pressable externally on an outside surface of the mandrel at the flare.

9. A method of fabricating a mandrel of composite material, the method comprising:
forming a shell having a first thread formed about an internal bore;
disposing the shell on a core;
forming the mandrel on the core and the shell by winding the composite material thereon;
removing at least a portion of the core from the shell.

10. The method of claim 9, wherein forming the shell comprises producing fixture elements on an external surface of the shell; and wherein forming the mandrel on the core and the shell comprises winding the composite material on the fixture elements of the shell.

11. The method of claim 9, wherein forming the shell comprises forming the shell as a sleeve having a thin sidewall thickness.

12. An apparatus for fabricating a mandrel of composite material, the apparatus comprising:
a core about which the composite material is wound for the mandrel;
a shell positioning on the core and about which the composite material is wound, the shell having a first thread formed about an internal bore.

13. A method of fabricating a mandrel of composite material, the method comprising:
disposing an expandable component on a core;
forming the mandrel on the core and the expandable component by winding the composite material thereon; and
forming a first thread internally on an inside surface of the mandrel by expanding the expandable component, unexpanding the expandable component, and removing at least the expandable component from the formed mandrel.

14. The method of claim 13, wherein expanding the expandable component comprises compressing a coil.

15. The method of claim 13, wherein expanding the expandable component comprises twisting a coil.

16. The method of claim 13, further comprising removing at least a portion of the core from the formed mandrel.

17. The method of claim 13, further comprising forming a second thread on the mandrel by:
initially disposing an expanded component on the core;
forming the mandrel on the core and the expanded component by winding the composite material thereon;
producing a flare of the wound composite material on the formed mandrel at the expanded component; and
forming the second thread externally on an outside surface of the mandrel by pressing the produced flare with a mold having a relief of the second thread.

18. An apparatus for fabricating a mandrel of composite material, the apparatus comprising:
a core about which the composite material is wound for the mandrel; and
an expandable component positioning on the core and about which the composite material is wound, the expandable component being expandable to an expanded condition with a first thread profile engageable internally on an inside surface of the mandrel.

19. The apparatus of claim 18, wherein the expandable component comprises a coil disposed on the core, the coil being compressible on the core and expanding outward to the expanded condition.

20. The apparatus of claim 19, wherein the expandable component comprises an end piece disposed on a portion of the core and movable on the portion of the core against the coil to compress the coil thereon to the expanded condition.

21. The apparatus of claim 19, wherein the expandable component comprises an end piece disposed on a portion of the core and being rotatable thereon to twist the coil to the expanded condition.
